(19) United States
(12) Patent Application Publication
(10) Pub. No.: US 2009/0241024 A1
(43) Pub. Date: Sep. 24, 2009

(54) INFORMATION PROCESSING APPARATUS, INFORMATION PROCESSING METHOD, AND PRINTING SYSTEM

(75) Inventor: Tetsuya Shiohara, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/408,488

(22) Filed: Mar. 20, 2009

(30) Foreign Application Priority Data
Mar. 21, 2008 (JP) 2008-074289

(51) Int. Cl. G06F 17/00; G06F 3/12

(52) U.S. Cl. 715/274; 358/1.15

(57) ABSTRACT

An information processing apparatus including a preview object unit configured to generate a preview document based on document data stored in a preview print queue. The preview object unit displays the preview document on a screen, and stores the preview document in a print command generation print queue. The information processing apparatus also includes a print command generation object unit configured to generate a print command based on the preview document stored in the print command generation print queue.

### BACKGROUND OF THE INVENTION

1. Field of the Invention

The present invention relates to an information processing apparatus, an information processing method, and a printing system.

2. Description of the Related Art

Conventionally, a technique to acquire a print image before printing and displaying the image on a screen has been proposed.

As an example of the technique, a technique has been known in which a print command interpretable by a printer is analyzed by a calculator (data processing apparatus) connected to a printer, and a print image is generated by converting the data for each cyan, magenta, yellow and black (CMYK) plane by the calculator. Further, a technique is known in which a print command is sent from a calculator connected to a printer, to the printer, the calculator receives a print image generated in the printer, and based on the received print image, the image is displayed.

In connection with the above techniques, in the printing system that employs a calculator in which WINDOWS® is installed as an operation system (OS), print data generated by an application program (application) is stored in a spool file in an OS standard data format. The OS calls up a printer driver to print the print data. The printer driver reads the print data stored in the spool file, generates a print image, and converts the data into a printer-interpretable print command. The print command is sent to the printer. The printer interprets the print command and forms an image on a recording medium. By the above-described processing, the print processing is performed.

In the printing system, to provide a preview function, when the print processing is started, the printer driver activates a previewer for displaying the print image. An image generation unit in the printer driver forms a print image for preview. Then, the previewer in the printer driver displays the print image for preview. More specifically, in the printer driver, the image generation unit that forms the print image and the previewer that displays the print image cooperate to implement the preview function (see Japanese Patent Application Laid-Open No. 2004-102618).

In the above-described technique discussed in Japanese Patent Application Laid-Open No. 2004-102618, while the printer driver is being called by the OS, the preview can be carried out. When the OS calls the printer driver and performs the print processing, a first print job in aprint queue is processed. Generally, only one print job in the print queue is processed. Accordingly, while the one print job is being processed, the other jobs are not processed. Therefore, if the print job that is being processed exists in the print queue, it may not be possible to implement the preview function of the other print jobs.

A printer driver that is installed in the print server in advance is downloaded from a print server to a client connected via a network, and installation is performed. In the OS of WINDOWS, Point & Print that enables the client to use the printer driver is provided. With respect to processing methods in the Point & Print environment using the print server, there are server-side rendering (SSR) that performs the driver processing at the server side and client-side rendering (CSR) that performs the driver processing at the client side. The print preview is carried out in the driver processing. Accordingly, in the case of the SSR environment, it is not possible to carry out the preview at the client side. Therefore, the user who is at the client side cannot view the preview of the print job. Accordingly, in the SSR environment of Point & Print, it is not possible to provide the print preview function.

### SUMMARY OF THE INVENTION

The present invention is directed to a method for performing preview of a subsequent print job before processing of a preceding print job is completed. Further, the present invention is directed to providing a preview function in a Point & Print environment.

An information processing apparatus including a preview object unit configured to generate a preview document based on document data stored in a preview print queue is provided. The preview object unit may display the preview document on a screen, and store the preview document in a print command generation print queue, and a print command generation object unit configured to generate a print command based on the preview document stored in the print command generation print queue.

According to another aspect of the present invention, an information processing apparatus including a preview object unit configured to generate a preview document based on document data stored in a preview print queue and display the preview document on a screen is provided. The information processing apparatus also includes a document transmission object unit configured to send the preview document to a server device registering a print command generation print queue.

According to yet another aspect of the present invention, a printing system having a client device and a server device is provided. The printing system includes a unit configured to display a preview document based on document data stored in a print queue in the client device. The unit sends the document data to a print queue in the server device. The printing system also includes a unit configured to generate a print command based on the print queue in the server device, and send the generated print command to a printer.

According to yet another aspect of the present invention, an information processing apparatus includes a first printer icon that is registered in a virtual port, and configured to display a preview document on a screen based on document data stored in a first queue and send the document data to a second queue. The information processing apparatus also includes a second printer icon that is registered in a port connected to a printer, and configured to generate a print command based on the document data stored in the second queue.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate numerous exemplary embodiments, features and aspects of the invention and, together with the description, serve to explain the principles of the invention.

FIG. 1 illustrates an example of a logic structure of an XML Paper Specification (XPS) document.

FIG. 2 illustrates an example of a configuration of a printing system.

FIG. 3 illustrates an example of a printer driver according to a first exemplary embodiment of the present invention.

FIG. 4 illustrates an example of a print setting dialogue that is displayed when print mode setting or various paper settings is performed.

FIG. 5 illustrates an example of a display screen (preview window) that is provided by a preview control module.

FIGS. 6A to 6F are schematic views illustrating relationships between print queues and print jobs.

FIGS. 7A and 7B illustrate a previewed flag to be stored in a PrintTicket (PT).

FIG. 8 is a flowchart illustrating an example of processing to merge PrintTicket (PT) of a FixedDocumentSequence (FDS) with a PT of a default print setting of a user and acquire a reference PT.

FIG. 9 is a flowchart illustrating an example of processing performed by a layout filter.

FIG. 10 is a flowchart illustrating an example of processing performed by a preview filter.

FIG. 11 illustrates an example of a printer driver according to a second exemplary embodiment of the present invention.

### DETAILED DESCRIPTION OF THE EMBODIMENTS

Various exemplary embodiments, features and aspects of the present invention will be described in detail below with reference to the drawings.

First, XPS is briefly described. XPS is an abbreviation of XML Paper Specification. XPS is an electric document format of open specification. An XPS document has a tree structure that has a FixedDocumentSequence (hereinafter, referred to as FDS) as a root. The FDS has a plurality of FixedDocuments (hereinafter, referred to as FD) . Each FD has a plurality of FixedPages (hereinafter, referred to as FP). Each of the FDS, FD, and FP is at times referred to as an XPS part. The FP describes contents of a page of a document in an XML format. The FP includes content to be displayed or printed. Resources such as fonts used in the page of the FP and an image can be shared by a plurality of FPs. Each of the FDS, FD, and FP can have print setting in a PrintTicket (hereinafter, referred to as PT). The PT describes print setting when printing the XPS document in the XML format. Here, the print setting used in printing each FP is a PT formed by merging a PT of a FDS, a PT of a parent FD of a print target FP, and a PT of the print target FP.

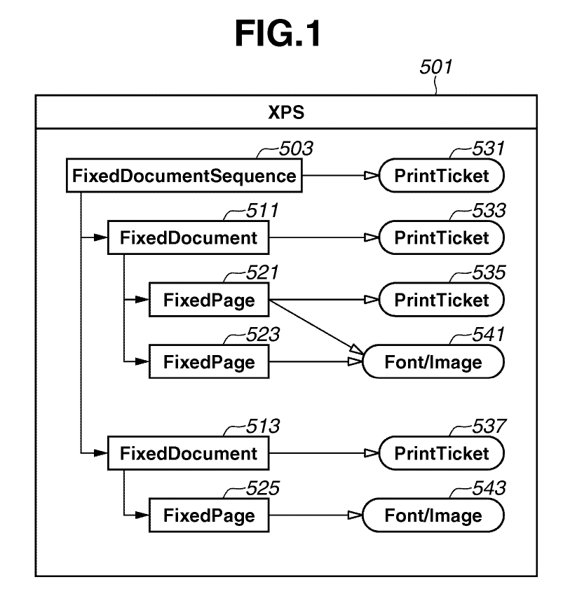

FIG. 1 illustrates an example of a logic structure of an XPS document. A logic structure of an XPS document 501 is a tree structure that has an FDS 503 as a root. The FDS 503 has an FD 511 and an FD 513 as its children. The FD 511 has an FP 521 and an FP 523 as its children. The FD 513 has an FP 525 as its child. With respect to PTs in which print setting is described, the FDS 503 has a PT 531, the FD 511 has a PT 533, the FP 521 has a PT 535, and the FD 513 has a PT 537, respectively. The FP 523 and the FP 525 do not have PTs. The FP 521 and the FP 523 share a resource 541 such as fonts and images. The FP 525 uses a resource 543 such as fonts and images. For example, a PT that is used when the FP 521 is printed is a PT formed by merging the PT 531, the PT 533, and the PT 535.

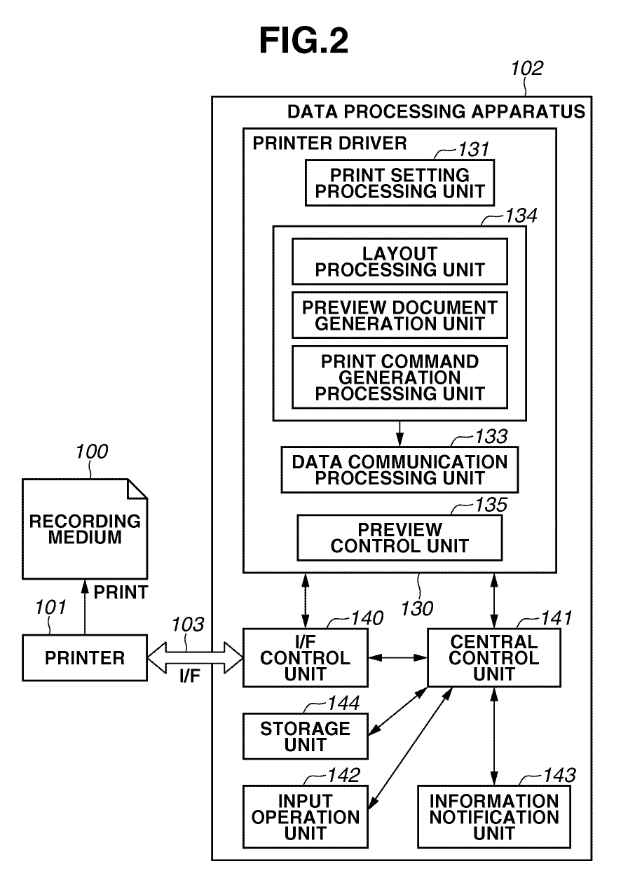

FIG. 2 illustrates an example of a configuration of a printing system. A printer 101 is an inkjet printer that performs image formation. The printer 101 performs image formation on a recording medium 100 according to a print command generated by a data processing apparatus 102 described below. The type of printer is not particularly specified. In the description, it is assumed that the printer is an inkjet color printer. In the data processing apparatus 102, an application generates a print job, and a printer driver generates a print command for controlling printing operation of the connected printer 101 from spool data of the print job. In the present exemplary embodiment, a personal computer may be used as the data processing apparatus 102 that is an example of an information processing apparatus. The data processing apparatus 102 also performs a function to receive instructions or input about print setting from a user.

The data processing apparatus 102 includes functional blocks 130, 131, 133 to 135, and 140 to 143. In the data processing apparatus 102, an OS for controlling the data processing apparatus 102 is installed. On the OS, the functional blocks operate. A communication interface 103 connects the data processing apparatus 102 and the printer 101. In the exemplary embodiment, it is assumed that a universal serial bus (USB), which is a serial interface, is used as the communication interface 103. However, as the communication interface 103, it is possible to use a serial interface such as IEEE 1394, Ethernet (registered trademark), Infrared Data Association (IrDA), IEEE 802.11, or an electric power line, or a parallel interface such as Centronics interface or Small Computer System Interface (SCSI). As long as the communication can be established, any wired or wireless interface can be used as the communication interface 103.

As described above, the printing system in the exemplary embodiment is not a single apparatus, but configured by the data processing apparatus 102 and the printer 101 that are connected with each other by the specific bidirectional interface. However, the printing system is not limited to the present embodiment, but an integrated printing system that has the functions of the data processing apparatus and the printer may also be used. In the description, descriptions of functions not particularly necessary in explaining features of the printer 101 and the data processing apparatus 102 in the exemplary embodiment are omitted.

A central control unit 141 controls various functions of the data processing apparatus 102, and the functions correspond to those of a central processing unit (CPU). An input operation unit 142 includes various input devices for enabling a user to configure the print setting. An information notification unit 143 notifies the user of the print setting. As the notification method, there is a method to use a display device such as a monitor, a method to notify by voice, and the like. An interface (I/F) control unit 140 controls an interface function of the data processing apparatus 102. The I/F control unit 140 includes a controller of a host side of the USB, and has a function of a USB host. A part of the functions as the USB host may also be formed by software such as an OS or a driver.

A storage unit 144 is used to store instruction codes of the OS, the application program, and the printer driver, and to temporarily store and read data when software operates. The storage unit 144 is formed by, for example, hard disk drive or a semiconductor memory. A printer driver 130 is software for performing various setting for printing, generation of print data, and control of the printer on the data processing apparatus 102. By implementing a program in the printer driver by the central control unit 141, functions of a print setting processing unit 131, a print command generation unit 134 that includes a layout processing unit, a preview document generation unit, and a print command generation processing unit, and a data communication processing unit 133, and the like are implemented.

The print setting processing unit 131 performs various print settings including the paper setting and the print quality setting. The print setting processing unit 131 has functions to receive an instruction or input from the user, and display or notify the setting. The print command generation unit 134 performs, in the layout processing unit, layout of a page of a print job generated by the application. Then, in the preview document generation unit, a preview document is generated based on the print setting. Then, in the print command generation processing unit, the layout-processed print data is converted into a print command. The print command generated in the print command generation unit 134 is sent to the I/F control unit 140 via the data communication processing unit 133, and the print command is sent to the printer 101.

A preview control unit 135 provides a preview function to the user using the preview document generated by the preview document generation unit. The preview function serves to display a print image using a preview document via the information notification unit 143, and acquire an instruction from the user via the input operation unit 142. Further, the preview function serves to switch print images to be displayed, continue printing, and cancel printing.

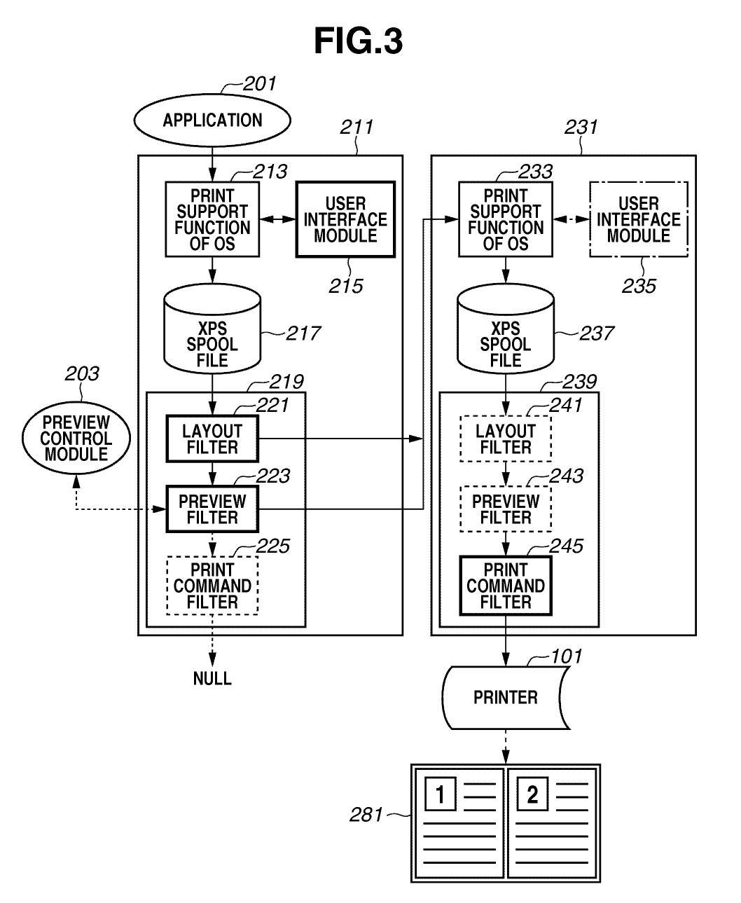

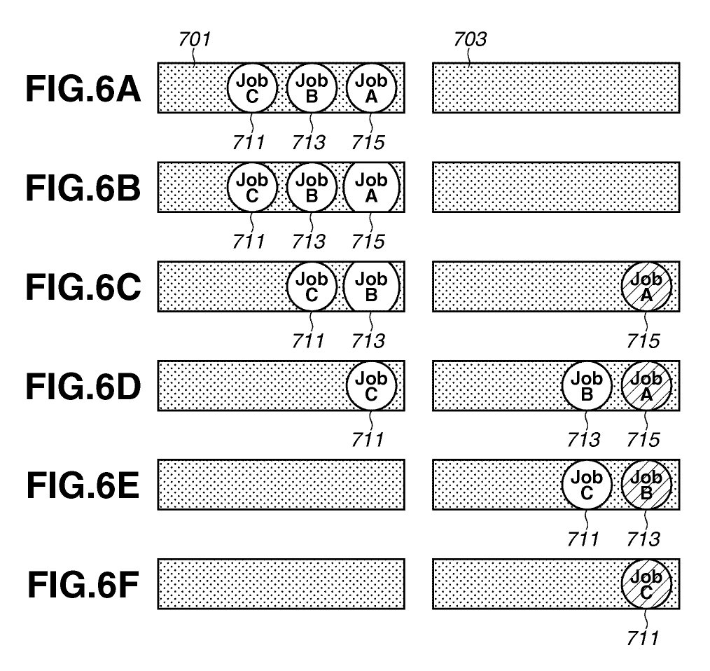

FIG. 3 illustrates an example of a printer driver according to the first exemplary embodiment of the present invention. In the exemplary embodiment, the data processing apparatus 102 includes a printer icon 211 that is an example of a preview object unit having a preview function, and a printer icon 231 that is an example of a print command generation object unit having a print command generation function. In the case of the OS of WINDOWS, for one registered printer icon, one print queue is registered. Therefore, in the exemplary embodiment, two print queues are registered in the data processing apparatus 102. For example, a first queue for preview is registered to the printer icon 211, and a second queue for printing is registered to the printer icon 231. The relationships between print queues and print jobs are described with reference to FIGS. 6A to 6F below.

In the printer icons, modules according to the exemplary embodiment are user interface modules 215 and 235 that have a print setting function, and filter groups (filter pipelines) 219 and 239. The filter group 219 includes a layout filter 221 that has a function to perform layout processing on a page of XPS data that is an example of document data, and a preview filter 223 that is a filter for providing the preview function. The filter group 239 includes a layout filter 241 that has a function to perform layout processing on a page of XPS data, and a preview filter 243 that provides the preview function.

The filter group 219 includes a print command filter 225 that has a function to convert XPS data into a printer-interpretable print command. The filter group 239 includes a print command filter 245 that has a function to convert XPS data into a printer-interpretable print command. Generally, the filter is a program (application) that has a function to output some data through steps of processing, conversion, non-conversion, generation, and the like based on input data.

As described above, in the exemplary embodiment, two printer icons of the same module structure are registered. The first printer icon performs the preview function. The second printer icon performs the print command generation function. Hereinafter, the first printer icon is referred to as a preview printer icon, and the second printer icon is referred to as a print command generation printer icon. The printer icons are registered, for example, by an installer, or copied by the driver itself at the time of installation.

The preview printer icon 211 and the print command generation printer icon 231 are, for example, registered to different ports by the printer driver 130. The preview printer icon 211 does not actually perform printing, and only provides the preview function. Accordingly, the preview printer icon 211 is registered (port allocation) to a NULL port (virtual port that is not connected to an actual device) that cannot print. In printing, first, the user performs an operation to send print data to the preview printer icon 211. The print command generation printer icon 231 is registered (port allocation) to a port (port connected to an actual device) specified by the user at the time of installation. The print command generation printer icon 231 converts data sent from the preview printer icon 211 into a printer-interpretable command. Accordingly, for example, the print command generation printer icon 231 (a user interface module 235 in the print command generation printer icon 231) is registered in a hidden state so that the user cannot directly use the print command generation printer icon 231.

The printer driver 130, for example, registers the print command generation printer icon 231 by attaching an attribute that denotes non-display of the printer icon on the screen. Alternatively, the printer driver 130 registers the print command generation printer icon 231 by attaching an attribute that denotes the print command generation printer icon 231 is displayed on the screen but the user is not permitted to select the print command generation printer icon 231. The information notification unit 143, for example, displays the print command generation printer icon 231 according to such an attribute in the hidden state so that the user cannot directly use the print command generation printer icon 231.

In the exemplary embodiment, the printer driver 130 registers (allocates) one virtual port as an output port to the preview printer icon 211. However, it is possible to register (allocate) a plurality of virtual ports as output ports. By registering the plurality of ports, it is possible to display a plurality of previews simultaneously.

In the printing system in FIG. 3, print data of each page of a document generated by an application 201 is temporarily stored in an XPS spool file 217 in the preview printer icon 211 via an OS print support function 213. The stored print data is previewed by the filter group 219 in the preview printer icon 211 based on the print setting information. The filter group 219 stores the print data into an XPS spool file 237 via OS print support function 233 in the print command generation printer icon 231. The print data is converted by the filter group 239 in the print command generation printer icon 231 into a print command that can be interpreted by the printer 101, and the print command is supplied to the printer 101. The printer 101 performs print to paper 281

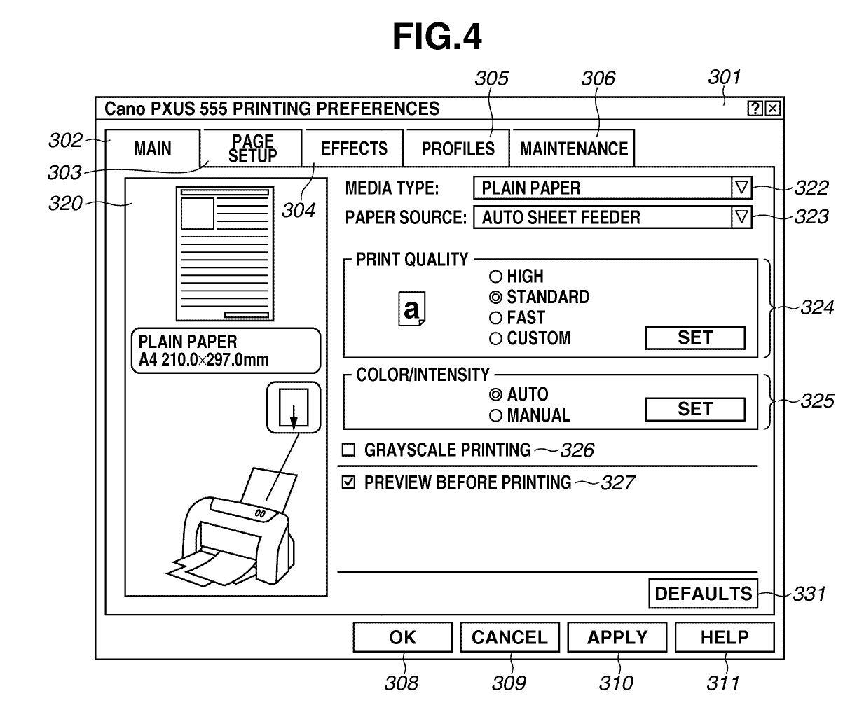

The user interface module 215 provides a function to set a size of paper used for printing, a print direction, and other attributes. Further, the user interface module 215 according to the exemplary embodiment has a function to set preview for displaying a print image before printing operation by the printer is started. The user interface module 215 returns the print setting information in which the set values of the plurality of print setting items are stored, to the application 201. An example of a print setting dialogue provided by the user interface module 215 is described with reference to FIG. 4 below. Actually, the user interface module 235 also exists in the print command generation printer icon 231. However, as described above, when the print command generation printer icon 231 is hidden such that the user cannot operate the printer icon 231, the icon 231 is not used.

The application 201, in printing the generated document, notifies the OS print support function 213 of printing start or printing end, and notifies the print setting information returned from the user interface module 215 to perform the print setting. Further, the application 201 notifies the OS print support function 213 of start or end of drawing of each page in the document. The OS print support function 213 stores the data drawn by the application or the print setting information into the XPS spool file 217 in the preview printer icon 211. Each filter is called by the OS print support function when the spooled print job is despooled.

The filter groups 219 and 239 in the icons include one or more filters. The filter groups 219 and 239 read print jobs from XPS spool files in printing, convert the data into print commands that can be interpreted by the printer 101, and supplies the printer commands to the printer 101. The filter group 219 according to the exemplary embodiment includes the layout filter 221 that functions as a layout processing unit, the preview filter 223 that functions as a preview document generation unit, and a print command filter 225 that functions as a print command conversion unit. The filter group 239 includes the layout filter 241 that functions as a layout processing unit, the preview filter 243 that functions as a preview document generation unit, and the print command filter 245 that functions as a print command conversion unit.

The layout filter 221 has functions to receive the XPS data stored in the XPS spool file 217 as an input, perform layout of a page based on the print setting information, and output laid-out XPS data. The layout filter 241 has functions to receive the XPS data stored in the XPS spool file 237 as an input, perform layout processing of a page based on the print setting information, and output laid-out XPS data. The layout processing according to the exemplary embodiment includes, for example, N-up printing for printing a plurality of pages on one sheet, a poster printing for printing one page on a plurality of sheets.

The layout filter 221, when the preview setting is ON, performs the layout based on the print setting, and sends the laid-out XPS data to a next filter. At the time of the layout, the layout filter 221 adds a laid-out flag to the print data. When the preview setting is OFF, the layout filter 221 adds a previewed flag to the input data, and stores the data in the XPS spool file 237 in the print command generation printer icon 231.

The layout filter 241, when the layout has already been performed (the laid-out flag is added) in the preview printer icon 211, directly sends the input print data to the next filter. When the layout is not performed in the preview printer icon 211, the layout filter 241 performs the layout based on the print setting, and sends the laid-out XPS data to the next filter.

The preview filters 223 and 243 receive output of the layout filters as input, and provide preview functions to the user based on the print setting.

The preview filter 223, when the preview setting in the print setting information is ON, generates preview XPS data storing the previewed flag in a PT that is the print setting information of a FDS, and performs preview by displaying the data. Then, the preview filter 223 stores the XPS data into the XPS spool file 237 in the print command generation printer icon 231, and ends the processing of the preview printer icon 211. The preview filter 243 checks that the previewed flag is stored, and directly outputs the input XPS data to the next filter.

The print command filter 245 receives the output of the preview filter 243 as input, converts the XPS data into a printer-interpretable print command based on the print setting information, and outputs the command. In a case where the print command filter 245 once converts the input XPS data into image data, generally, the filter is referred to as a render filter. The render filter is often used in a printer driver for an inexpensive raster printer such as an inkjet printer. When the print command filter 245 operates as the render filter, the print command filter 245 once converts the input XPS data into image data. Then, the print command filter 245 performs image processing such as conversion of a color space, binarization, or the like on the image data, and converts the data into a print command that can be interpreted by the raster printer. In a high-performance printer such as a page printer, if an XPS is included in a print command that can be interpreted by the printer, the print command filter 245 edits input XPS data, and outputs the edited XPS data. If it is not necessary to perform processing in the print command filter 245, the print command filter 245 directly outputs the input XPS data. Alternatively, the print command filter 245 is not included in the printer driver.

The print command filter 225 has a function similar to that of the print command filter 245. However, in the exemplary embodiment, the processing proceeds to the print command generation printer icon before the process by the preview filter 223. Accordingly, the print command 225 is not used.

The printer 101 that functions as an output device has functions to analyze the print command generated in the print command filter 245, and forms a visible image on a print sheet. An example of a print result formed on a print sheet 281 shows a case where 2-up processing is performed by the layout filter 221 or the layout filter 241.

FIG. 4 illustrates an example of a print setting dialogue that is displayed when a print mode setting or various media setting is performed. In FIG. 4, aprint setting dialogue 301 includes display areas 302 to 306, 308-311, 320, 322-327 and 331. In print setting, there are a lot of items to be displayed. Accordingly, generally, the setting items are categorized according to contents using tab sheets to make it easy to view the dialogue.

FIG. 4 illustrates a display example when a main tab 302 is selected. In a simple display area 320 on the main tab 302, not only character information but also visual information is displayed. On a media type selection part 322, types of media are displayed. The user can select one of the media types. The media type selection section 322 is formed as a drop-down menu, and a selected medium type is displayed. When the user clicks the drop-down menu, a list of types of media that can be selected is displayed. The types of media that can be selected are media on which the printer can perform printing. In addition to plain paper that is illustrated in the drawing, the types of media include glossy paper, coated paper, photo paper, a postcard, and the like.

A paper source selection section 323 displays paper supplying methods used in the printer body so that the user can select a paper supplying method. Using the paper source selection section 323, the user can select, for example, a paper feed tray or a paper feed cassette that is an automatic paper feed port, a manual feed port for manually feeding printing paper one by one, or the like. In a print quality selection section 324, the user sets quality of printing. In a color adjustment section 325, the user adjusts a print color. A grayscale printing setting section 326 is a checkbox for printing a document in grayscale even if the print document is a color document. A preview print setting section 327 is a checkbox for checking how various print settings appear on a print document before printing by the printer. When a default setting section 331 is pressed, the setting on the main tab 302 returns to default (factory setting).

When an OK button 308 is pressed after the user selected a setting item, the printer driver 130 closes the print setting dialogue 301, and implements the selected print setting on the printing. When the user presses a cancel button 309, the printer driver 130 closes the print setting dialogue 301, the selected setting items are discarded, and the setting is not implemented on the printing. When an apply button 310 is pressed by the user, the printer driver 130 implements the selected print setting on the printing while the print setting dialogue 301 is opened. When the user presses a help button 311, the printer driver 130 displays a help text about each setting item in the main tab 302 on another window.

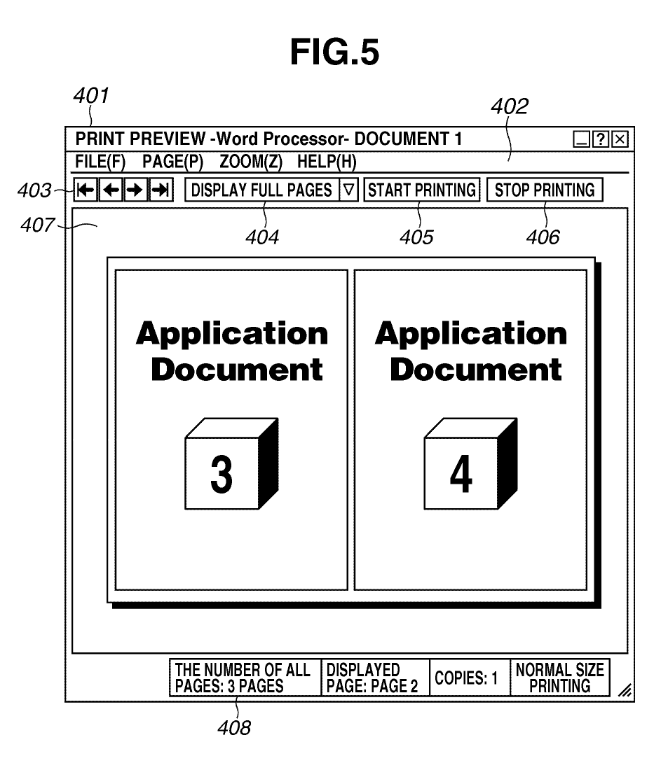

FIG. 5 illustrates an example of a display screen (preview window) that is provided by a preview control module 203. A print preview window 401 functions as a display area to display a preview image, a print setting of a print job, or the like, and also functions as an input unit to change display methods of a preview image, or the like.

On a menu bar 402, the user can select an instruction such as an instruction to switch display to a previewer, in a menu form. An area where user operation sections 403 to 406 are provided is a toolbar. The user can easily switch preview pages, or the like by pressing the button 403 without using the menu bar 402. The page switching button 403 includes the four buttons. By using the page switching button 403, the user can switch a preview display to a top page, a previous page, a next page, or a final page.

The drop-down list 404 is used to change a display size of a preview image. By operating the drop-down list 404, the user can select a full page display, 100% display, 200% display, or the like. By pressing the print start button 405, the user can end the previewer, and the preview XPS document being previewed is printed. By pressing the print stop button 406, the user can end the previewer, and cancel the print job. On a preview display area 407, using contents of a preview XPS file, a print medium and a visible image to be formed on the print medium can be displayed as a print image. A display area 408 displays set values of representative setting items about a print job that is implementing the preview function. In an example illustrated in FIG. 5, a total number of pages of the document is three, the page number currently being viewed is two, the number of copies set in the print setting is one, and normal size printing is set.

According to the present exemplary embodiment, the display screen illustrated in FIG. 5, the print job including print setting information that the preview setting is ON is spooled, and by the OS print support function, the filter pipelines are started up. At a time when the preview control module 203 is started up, the preview filter is displayed.

Generally, the number of documents that can be printed at the same time on one printer is one. Accordingly, the OS has logical queues to manage a plurality of print jobs for every printer. Generally, the queues are referred to as print queues. A processing state of a first print job of the queue becomes “in printing” and the first print job becomes a processing target of the printer driver. FIGS. 6A to 6F are schematic views illustrating an example for describing relationships between print queues and preview of print jobs. Among the print jobs illustrated in FIGS. 6A to 6F, a Job A and a Job B store print setting information that the preview setting is ON.

In FIG. 6A, in a print queue 701 that is an example of the preview print queue, three print jobs are stored. In FIG. 6A, a first Job A 715 is in a “printing” state, and Job B 713 and Job C 711 are in a “waiting” state. The print setting information of the Job A 715 shows that the preview setting is ON. Accordingly, a preview XPS document is generated to display preview of the Job A 715 and the print state shifts to a state illustrated in FIG. 6B.

In FIG. 6B, preview of the Job A 715 is displayed. While the preview is displayed, it is not possible to process the subsequent Job B 713 and the Job C 711. Here, it is assumed that in the preview of the Job A 715, print start is instructed by the user. In the case, the preview filter 223 generates a new print job, and stores a preview XPS document in a print queue 703 of another printer icon generated at the time of the driver installation. The print queue 703 is an example of print queue for print command generation. The above state is illustrated in FIG. 6C.

In FIG. 6C, since the Job A 715 is a first print job of a print queue 703, the print state shifts to “in printing”. It can be seen that the Job A 715 is a print job that has already been previewed since a previewed flag is stored. Accordingly, preview is not performed on the Job A 715, and a print command that can be interpreted by the printer is generated by the filter pipeline. Then, an image is formed on a print medium by the printer.

The Job B 713 becomes a first print job of the print queue 701, and the print state shifts to “in printing”. Since in the print setting information of the Job B 713, the preview setting is ON, a preview XPS document is generated to display preview of the Job B 713. Thus, while the print processing of the Job A 715 is being performed, it is possible to display the preview of the subsequent Job B 713. When the Job B 713 is previewed, if print start is instructed by the user, the print state shifts to a state illustrated in FIG. 6D.

In FIG. 6D, the previewed Job B 713 is stored in the print queue 703. If the print command generation processing of the Job A 715 is not finished, the Job B 713 is in a “waiting” state since the Job A 715 that is the first print job in the print queue 703 is in processing. Then, the Job C 711 becomes a first print job of the print queue 701, and shifts to the “printing” state. In the print setting information in the Job C 711, the preview setting is OFF. Accordingly, preview is not performed and the Job C 711 is immediately stored in the print queue 703. This state is illustrated in FIG. 6E.

In FIG. 6E, the Job C 711 is stored in the print queue 703. When the processing of the Job A 715 is finished at this stage, the Job B 713 becomes the first print job. Accordingly, the Job B 713 is in a “processing” state. Since the first print job is the Job B 713, the newly stored Job C 711 is in “waiting” state. When the processing of the Job B 713 is finished at this stage, the print state shifts to a state in FIG. 6F, and print command generation processing of the Job C 711 is started.

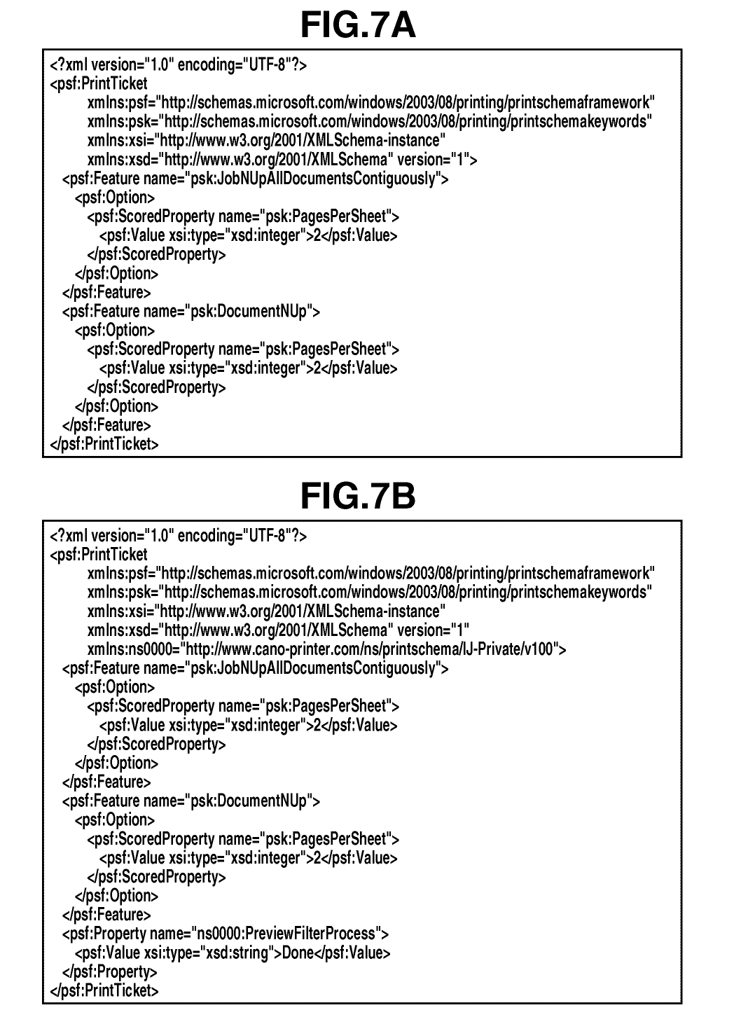

The previewed flag to be stored in a PT is described with reference to FIGS. 7A and 7B. FIGS. 7A and 7B illustrates a previewed flag to be stored in a PT. As described above, the PT is print setting described in the XML format. Accordingly, the PT can be expressed by text, and it is possible to visually describe the PT as illustrated in FIG. 7A.

The PT in FIG. 7A illustrates an example of print setting that specifies 2-up as layout setting. Standard description of the PT are defined by a schema named PrintSchema, and setting items about N-up are also included. PrintSchema is open to the public, and accordingly, description about PrintSchema is omitted. The PT includes, as N-up setting, JobNUpAllDocumentsContiguously that influences an FDS and DocumentNUp that influences an FD. These setting are defined by PrintSchema. The print driver is required to exclusively use the two print setting. The print setting to be prioritized depends on the printer driver. In FIG. 7A, 2-up is specified in both of the two print setting so that the both setting may be made.

In the print setting, there are many other setting items. However, here, only N-up that relates to the exemplary embodiment has been described. Moreover, depending on setting items, not only an FDS and an FD, but also an FP may be influenced.

FIG. 7B illustrates an example of a PT that the PT in FIG. 7A stores the above-described previewed flag. The previewed flag to be stored in the PT is unique information that is not defined by PrintSchema. Accordingly, it is necessary to add a private name space. In FIG. 7B, the private name space is shown as “ns0000.” The previewed flag to be stored is expressed as a value of Property using a framework of PrintSchema. In FIG. 7B, as a name attribute of Property, “ns0000:PreviewFilterProcess” is described. Further, by describing a string value of “Done” as the value, the previewed flag is expressed. The printer driver determines that preview has not been performed when “ns0000:PreviewFilterProcess” is not contained in the PT, or when “ns0000:PreviewFilterProcess” is contained in the PT and its value is a value other than “Done”.

In FIGS. 7A and 7B, in order to store the previewed flag, Property of the framework is used. However, Feature/Option may also be used. Further, a private name space that shows a previewed flag may be provided, and a previewed flag may be expressed based on existence of the name space. Further, since the PT is described in XML, as long as PrintSchema is applied, the previewed flag may be stored in any expression. Further, the laid-out flag may also be stored in a method similar to that of the previewed flag.

In the individual filters in the filter pipelines, to acquire print setting information, it is necessary to merge the PTs in the XPS, as described above. Each part in the XPS document can contain the PT. However, it is also possible that the XPS part does not contain the PT. Further, even if an XPS part contains the PT, as the PT illustrated in FIG. 7A, it is possible that the PT contains only the description of the information of N-up. Accordingly, when a PT of an FDS is acquired, the merging of user's default print setting and the PT is necessary. In the PT of the default print setting, all print setting items that may be used in the printer driver are stored. Accordingly, the merged PT contains the all print setting items.

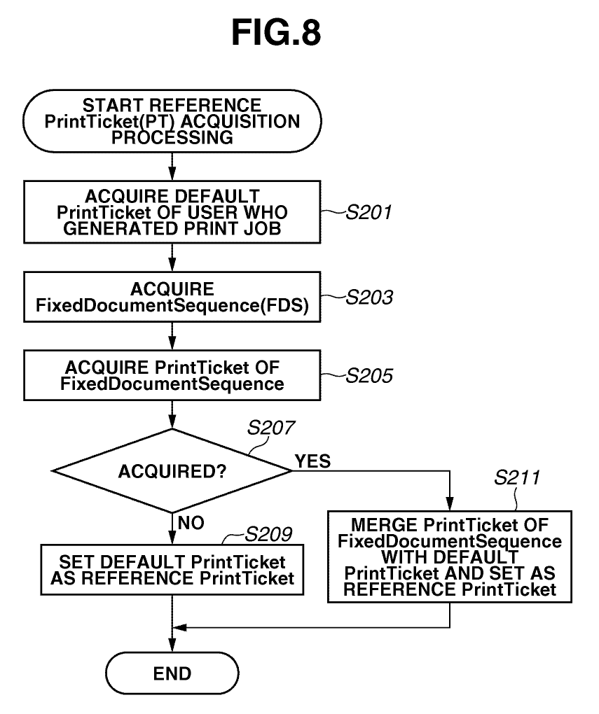

FIG. 8 is a flowchart illustrating an example of processing to merge a PT of a FDS with a PT of user's default print setting and acquire a reference PT. In FIG. 8, the layout filter 221 is described as an example.

In step S201, the layout filter 221 acquires a default PT in which default print setting of the user is stored. Then, in step S203, the layout filter 221 acquires an FDS of an XPS document. In step S205, the layout filter 221 acquires a PT of the FDS.

In step S207, the layout filter 221 determines whether the PT of the FDS is acquired. If the PT is acquired (YES in step S207), the processing proceeds to step S211. If the PT is not acquired (NO in step S207), the processing proceeds to step S209. In step S211, the layout filter 221 defines the PT obtained by merging the acquired FD with the default PT as a reference PT, and the processing illustrated in FIG. 8 ends. In step S209, since the PT is not contained in the FDS, the layout filter 221 defines the default PT as the reference PT, and the processing illustrated in FIG. 8 ends.

In the description, the all setting items are those that can be set at least by the application but do not include setting items within the printer driver such as the previewed flag.

By performing the processing illustrated in FIG. 8, it is possible to acquire the reference PT that contains all setting items that can be used by the printer driver.

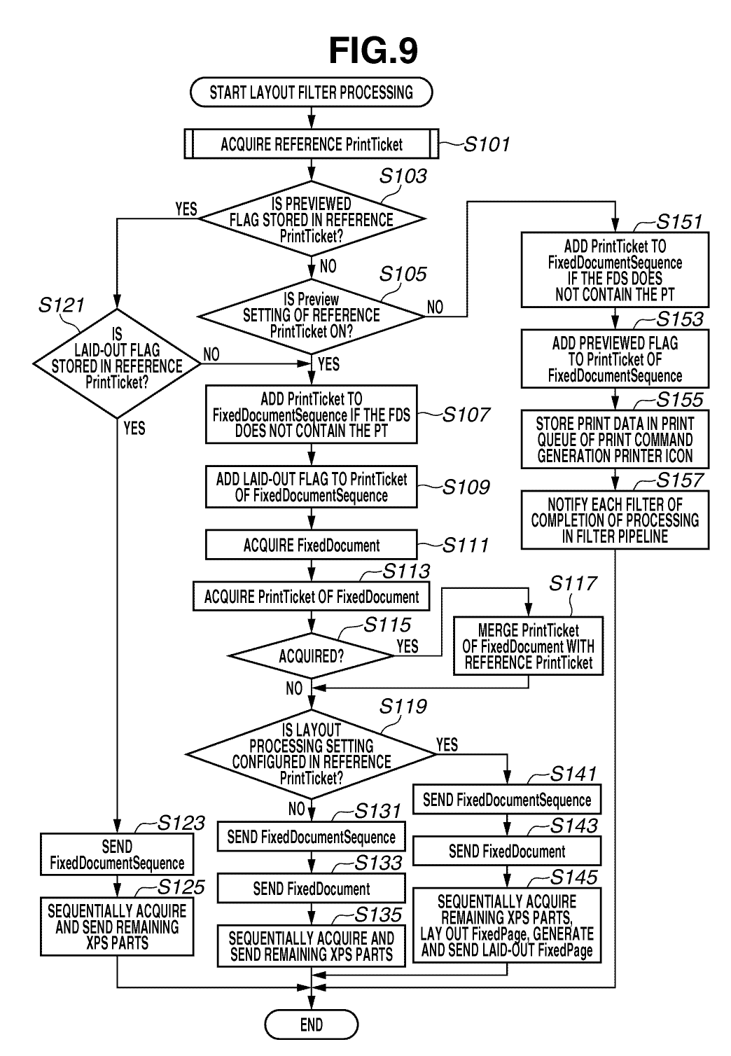

FIG. 9 is a flowchart illustrating an example of processing performed by the layout filter 221.

In step S101, as described above, the layout filter 221 acquires the reference PT. In step S103, the layout filter 221 determines whether a previewed flag is stored in the reference PT. If the reference PT is stored (YES in step S103), the processing proceeds to step S121. If the reference PT is not stored (NO in step S103), the processing proceeds to step S105.

In step S105, the layout filter 221 determines whether preview setting in the print setting information in the reference PT is ON. If the preview setting is ON (YES in step S105), the processing proceeds to step S107. When the preview setting is not ON (NO in step S105), the processing proceeds to step S151. In steps S107 to S109, the layout filter 221 stores a laid-out flag. Since the laid-out flag is stored in the PT of the FDS, first, the layout filter 221 checks whether the PT exists in the FDS. When the PT is not contained in the FDS, the layout filter 221 adds the PT to the FDS. Then, the layout filter 221 stores the laid-out flag in the PT of the FDS. The operation has to be performed before the FDS is sent.

In step S111, the layout filter 221 acquires an FD. In step S113, the layout filter 221 acquires a PT from the FD. In step S115, the layout filter 221 determines whether the PT in the FD is acquired. If the PT is acquired (YES in step S115), the processing proceeds to step S117. If the PT is not acquired (NO in step S115), the processing proceeds to step S119. In step S117, the layout filter 221 merges the reference PT with the acquired PT in the FD.

In step S119, the layout filter 221 determines whether layout setting is set in the print setting information of the reference PT. If the layout setting is set (YES in step S119), the processing proceeds to step S141. If the layout setting is not set (NO in step S119), the processing proceeds to step S131. In steps S131 to S135, the layout filter 221 outputs the input XPS data without performing the layout processing. In step S131, the layout filter 221 outputs the acquired FDS. In step S133, the layout filter 221 outputs the acquired FD. In step S135, the layout filter 221 acquires remaining XPS parts from the input, outputs the acquired XPS parts, and the processing ilustrated in FIG. 9 ends.

In steps S141 to S145, the layout filter 221 performs the layout processing on the input XPS data, and outputs the data. In step S141, the layout filter 221 outputs the acquired FDS. In step S143, the layout filter 221 outputs the acquired FD. In step S145, the layout filter 221 sequentially acquires remaining XPS parts from the input, generates a laid-out FP that is layout-processed, and outputs the FP.

As described above, in the layout setting that is stored in the PT, there are layout settings that influence the FDS and layout settings that influence the FD. Accordingly, the layout filter 221 also outputs the FD if necessary. As described above, the layout filter 221 sends the newly generated laid-out FP, outputs all FPs, and the processing illustrated in FIG. 9 ends.

Processing in steps S151 to S157 is performed when the preview setting in the print setting information of the reference PT is OFF. First, when the previewed flag that shows that the processing in the preview printer icon 211 is performed, is stored in the FDS, in step S151, the layout filter 221 checks whether the PT is contained in the FDS. If the PT is not contained, the layout filter 221 adds the PT to the FDS. Then, in step S153, the layout filter 221 stores the previewed flag in the PT in the FDS. In step S155, the layout filter 221 stores the print data storing the previewed flag in a print queue in the print command generation printer icon 231. In step S157, the layout filter 221 sends notifications of process end to each of the filters, and the processing illustrated in FIG. 9 ends.

In step S121, the layout filter 221 determines whether the laid-out flag is stored in the reference PT. If the laid-out flag is stored (YES in step S121), the processing proceeds to step S123. If the laid-out flag is not stored (NO in step S121), the processing returns to step S107. In the steps after step S107, the layout processing is performed as described above. The laid-out print data is sent to the next filter, and the processing illustrated in FIG. 9 ends. In steps S123 to S125, since the input print data has already been layout-processed by the preview printer icon 211, the input data is sent to the next filter, and the processing illustrated in FIG. 9 ends.

Even if the preview setting in the print information is OFF, the layout filter 221 may not directly send the print data. Instead, unlike the above-described method, the layout filter 221 may send the print data to the print command generation printer icon 231 after the layout processing is performed. In such a case, the layout processing is always finished in the preview printer icon 211. Accordingly, the laid-out flag is not necessary.

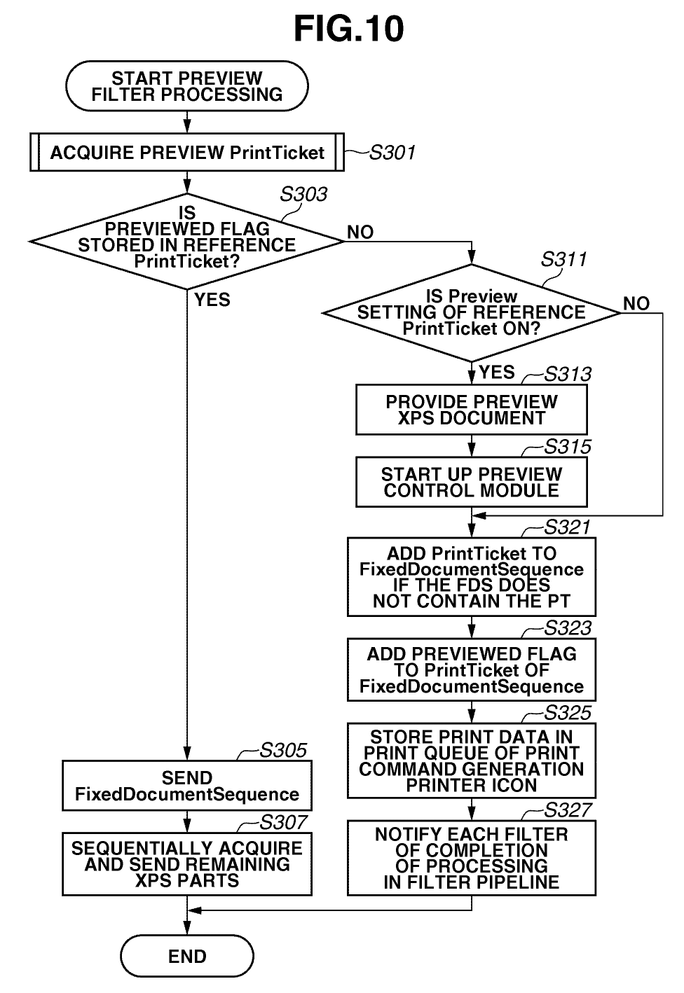

FIG. 10 is a flowchart illustrating an example of processing performed by the preview filter 223.

In step S301, the preview filter 223 acquires the reference PT as described above. In step S303, the preview filter 223 determines whether a previewed flag is stored in the reference PT. If the previewed flag is stored in the reference PT (YES in step S303), the processing proceeds to step S305. If the previewed flag is not stored in the reference PT (NO in step S303), the processing proceeds to step S311.

Processing in steps S305 to S307 is performed on the print job that has already been processed by the preview printer icon 211. More specifically, since the preview is being performed by the preview printer icon 211 or the preview setting in the print setting information is OFF, the preview filter 223 does not perform preview, sequentially acquires XPS parts, and sends the parts to the next filter. In step S311, the preview filter 223 determines whether the preview setting in the print setting information in the reference PT is ON. If the preview setting is ON (YES in step S311), the processing proceeds to step S313. If the preview setting is not ON (NO in step S311), the processing proceeds to step S321.

Processing performed in steps S313 to S315 is preview execution processing. In step S313, the preview filter 223 forms a preview XPS document. In step S315, the preview filter 223 starts up the preview control module 203, and executes preview by displaying the preview XPS document formed in step S313. In the preview, when print start is instructed by the user, the processing in the preview filter 223 proceeds to step S321.

Processing performed in steps S321 to S327 is processing for transmitting print data to the print command generation printer icon 231. First, in steps S321 and S323, the preview filter 223 stores the previewed flag in the formed preview XPS document. In step S325, the preview filter 223 stores the preview XPS document storing the previewed flag in a print queue in the print command generation printer icon 231. Then, in step S327, the preview filter 223 sends notifications of process end to the individual filters, and the processing illustrated in FIG. 10 ends.

As described above, in the present exemplary embodiment, even if the preceding job is in printing, the preview of the succeeding job can be performed.

In the first exemplary embodiment, the method to perform the preview of the subsequent job during printing is described. In a second exemplary embodiment of the present invention, a method to provide a print preview function in a Point&Print environment is described. Hereinafter, it is assumed that SSR is set in the Point&Print environment. Descriptions about parts that perform processing similar to those in the first exemplary embodiment are omitted.

In the Point&Print environment, a client device downloads and installs a printer driver that is installed in a server device, in advance. The installed printer driver is registered to the client device as a printer icon of Point&Print. Using the printer icon, the client device can perform printing with a printer connected to the server device.

In the second exemplary embodiment, similar to the first exemplary embodiment, registration of two printer icons is performed. The first printer icon is registered as the printer icon of Point&Print. The second printer icon is registered as a local printer icon in the client device using the same module.

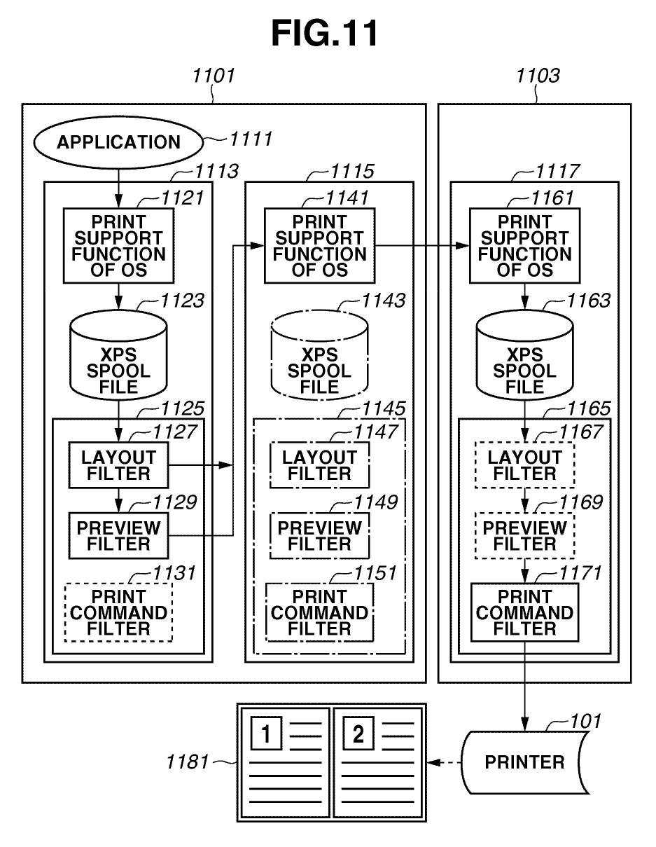

FIG. 11 illustrates an example of a printer driver according to the second exemplary embodiment of the present invention. In FIG. 11, a server device 1103 is connected to the printer 101, and the server device 1103 is used as a print server. A client device 1101 uses the server device 1103 to perform printing.

As described above, in the second exemplary embodiment, in the client device 1101, the two printer icons of the same module structure are registered. A first printer icon 1113 is registered as the local printer icon of the client device 1101, and performs a preview function. A second printer icon 1115 that is an example of a document transmission object is registered as the Point&Print printer icon of the client device 1101, and performs a print data transmission function to the server device 1103. Hereinafter, the first printer icon is referred to as a local printer icon, and the second printer icon is referred to as a Point&Print printer icon. The registration of the icons is, for example, performed by the driver itself when the printer driver is downloaded and installed from the server device 1103.

The local printer icon 1113 does not actually perform printing, and provides only the preview function. Accordingly, the local printer icon 1113 is registered in a port that cannot perform printing. When the user requests printing, first, print data is sent to the local printer icon 1113. The Point&Print printer icon 1115 sends the data sent from the local printer icon 1113 to the server device 1103. Accordingly, the Point&Print printer icon 1115 is registered in a hidden state so that the user cannot directly use the Point&Print printer icon 1115. A printer icon 1117 registered in the server device 1103 converts the print data into a command that can be interpreted by the printer.

In the printing system in FIG. 11, print data of each page in a document formed by an application 1111 is temporarily stored in an XPS spool file 1123 in the local printer icon 1113 via an OS print support function 1121. The print data is previewed based on print setting information by the local printer icon 1113, and the data is sent to the Point&Print printer icon 1115. The print data is sent to the server device 1103 by the Point&Print printer icon 1115, and stored in an XPS spool file 1163 in the printer icon 1117 registered in the server device 1103. The printer icon 1117 in the server device 1103 converts the print data into a print command that can be interpreted by the printer, and supplies the command to the printer 101. The printer 101 performs print to paper 1181.

The Point&Print printer icon 1115 is formed by the module same as the printer icon 1117 registered in the server device 1103. The Point&Print printer icon 1115 has a function to send print data to the server device 1103. As described above, with respect to the rendering methods in the Point & Print environment, there are SSR that performs rendering at the server side and CSR that performs rendering at the client side. In the CSR environment, print data is stored in an XPS spool file 1143, the print data is converted into a print command by a filter pipeline 1145 including a layout filter 1147, a preview filter 1149, and a print command filter 1151, and the print command is sent to the server device 1103. In such a case, since the processing is performed by a preview filter 1149 in the client device 1101, preview display can be performed. However, in the SSR environment, the print data is not stored in the XPS spool file 1143, and the data is sent to the server device 1103 by an OS print support function 1141. Then, the data is stored in an XPS spool file 1163 of the server device side via OS print support function 1151, and processing of the print data is performed by a filter pipeline 1165. In such a case, the processing of the print data by the preview filter 1149 at the client device side is not performed. Accordingly, it is not possible to perform preview display in the client device 1101.

To perform preview display, in the exemplary embodiment, the local printer icon 1113 that performs the preview function is provided, so that it is possible to perform the processing up to the preview filter in the filter pipeline, in the client device. Hereinafter, processing performed in each printer icon according to the second exemplary embodiment is described with reference to FIG. 11.

The local printer icon 1113 in the second exemplary embodiment performs processing similar to that in the preview printer icon 211 in the first exemplary embodiment.

A filter group 1125 in the local printer icon includes one or more filters. The filter group 1125 has functions to read a print job from an XPS spool file at the time of printing, perform layout processing and preview processing on the read print data, and send the print data to the Point&Print printer icon 1115. The filter group 1125 includes a layout filter 1127 that functions as a layout processing unit, a preview filter 1129 that functions as a preview document generation unit, and a print command filter 1131 that functions as a print command conversion unit.

The layout filter 1127 functions to receive XPS data stored in the XPS spool file 1123 as input, perform layout processing based on the print setting information, and output the laid-out XPS data. The layout processing in the exemplary embodiment includes, for example, N-up printing for printing a plurality of pages on a sheet, a poster printing for printing one page on a plurality of sheets, and the like.

The layout filter 1127, when the preview setting is ON, performs layout processing based on the print setting, and sends the laid-out XPS data to the next filter. At that time, the layout filter 1127 adds a laid-out flag to the print data. When the preview setting is OFF, the layout filter 1127 adds a previewed flag to the input data, and sends the print data to the Point&Print printer icon 1115, and the processing in the local printer icon 1113 ends.

The preview filter 1129, when the preview setting in the print setting information is ON, generates preview XPS data storing the previewed flag in a PT that is the print setting information of a FDS, and performs preview by displaying the data on a screen. Then, the preview filter 1129 sends the XPS data to the Point&Print printer icon 1115, and ends the processing of the local printer icon 1113. When the preview setting is OFF, in the layout filter 1127, the print data is sent to the Point&Print printer icon 1115, and the processing of the local printer icon 1113 ends. Accordingly, the processing of the data in the preview filter 1129 is not performed. Similarly, since the processing of the local printer icon 1113 ends in the layout filter 1127 or the preview filter 1129, the print command filter 1131 does not perform processing of the data.

The Point&Print printer icon 1115 includes one or more filters. The Point&Print printer icon 1115 has a function to send print data to the printer icon 1117 in the server device 1103. The Point&Print printer icon 1115 is formed by the same module as the printer icon 1117 in the server device 1103. In a CSR environment, the Point&Print printer icon 1115 performs the same function as the print command generation printer icon 231 in the first exemplary embodiment, and the filter group (filter pipeline) 1145 converts XPS data into a print command that can be interpreted by the printer. The generated print command is sent to the printer icon 1117 in the server device 1103. In an SSR environment, the received data is directly sent to the printer icon 1117 in the server device 1103.

The printer icon 1117 in the server device 1103 has the same module structure as the Point&Print printer icon 1115, and performs a function to send a print command to the printer. In the CSR environment, the printer icon 1117 receives the print command generated by the Point&Print printer icon 1115, and sends the command to the printer 101. In the SSR environment, the printer icon 1117 performs the same function as the print command generation printer icon 231 in the first exemplary embodiment, and the filter group 1165 (filter pipeline) converts XPS data into a print command that can be interpreted by the printer. Hereinafter, operation of the printer icon 1117 in the server device 1103 in the SSR environment is described. The filter group 1165 in the printer icon 1117 in the server device 1103 includes a layout filter 1167 that performs layout, a preview filter 1169 that generates a preview document, and a print command filter 1171 that converts data into a print command.

The layout filter 1167, when the layout processing has already been performed (the laid-out flag is added) by the layout filter 1127 in the local printer icon 1113, sends the input print data to the next filter. When the layout processing is not performed by the layout filter 1127 in the local printer icon 1113, the layout filter 1167 performs the layout processing based on the print setting, and sends the laid-out XPS data to the next filter.

The preview filter 1169 checks that the previewed flag is stored, and directly outputs the input XPS data to the next filter. The print command filter 1171 receives the output of the preview filter 1169 as input. Then, the print command filter 1171 converts the XPS data into a print command that can be interpreted by the printer based on the print setting information, and outputs the command to the printer 101.

As described above, in the second exemplary embodiment, in the SSR environment of Point&Print, even if the print command conversion processing is to be performed at the server side, it is possible to provide the preview function at the client side.

An aspect of the present invention can also be achieved by providing the system or the device with a computer-readable storage medium (or a recording medium). The storage medium records a program code of software implementing the functions of the above-described exemplary embodiments and by reading and executing the program code stored in the storage medium with a central processing unit (CPU or MPU) of the system or the device. In this case, the program code itself, which is read from the storage medium, implements the functions of the exemplary embodiments mentioned above, and accordingly, the storage medium storing the program code constitutes the present invention.

In addition, the functions according to the exemplary embodiments described above are implemented by executing the program code read by the central processing unit, and an operating system (OS) or the like carries out a part of or the whole of the actual processing on the basis of the instruction given by the program code.

Further, in another aspect of the exemplary embodiments of the present invention, it is assumed that the program code read from the storage medium is written in a function enhancing card inserted in the system or the device or a memory which is provided in a function enhancing unit connected to the system or the device. Then, based on the instructions of the program code, the CPU or the like provided in the function enhancing card or the function enhancing unit carries out a part of or the whole of the actual processing to implement the function of the exemplary embodiments described above.

When the exemplary embodiments of the present invention are applied to the storage medium, in the storage medium (computer-readable storage medium), the above-described program code corresponding to the flowcharts is stored.

Further, according to the exemplary embodiments of the present invention, before processing of a preceding print job is finished, preview of a subsequent print job can be performed. Further, according to the exemplary embodiments of the present invention, in a Point&Print environment, the preview function can be provided.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-074289 filed Mar. 21, 2008, which is hereby incorporated by reference herein in its entirety.

What is claimed is:

1. An information processing apparatus comprising:
a preview object unit configured to generate a preview document based on document data stored in a preview print queue, display the preview document on a screen, and store the preview document in a print command generation print queue; and
a print command generation object unit configured to generate a print command based on the preview document stored in the print command generation print queue.

2. The information processing apparatus according to claim 1, further comprising:
a port allocation unit configured to allocate a port that is connected to an actual device, to the print command generation object unit.

3. The information processing apparatus according to claim 1, wherein the preview object unit receives operation by a user, and the print command generation object unit does not receive the operation by the user.

4. The information processing apparatus according to claim 1, further comprising:
a port allocation unit configured to allocate a virtual port that is not connected to an actual device, to the preview object unit.

5. The information processing apparatus according to claim 4, wherein the port allocation unit allocates a plurality of virtual ports that are not connected to an actual device, to the preview object unit.

6. An information processing apparatus comprising:
a preview object unit configured to generate a preview document based on document data stored in a preview print queue and display the preview document on a screen; and
a document transmission object unit configured to send the preview document to a server device registering a print command generation print queue.

7. A method in an information processing apparatus having a preview object unit and a print command generation object unit, the method comprising:
causing the preview object unit to generate a preview document based on document data stored in a preview print queue, display the preview document on a screen, and store the preview document in a print command generation print queue;
causing the preview object unit to generate a print command based on the preview document stored in the print command generation print queue.

8. The method according to claim 7, further comprising:
allocating a port that is connected to an actual device, to the print command generation object unit.

9. The method according to claim 7, further comprising:
causing the preview object unit to receive operation by a user; and
causing the print command generation object unit not to receive the operation by the user.

10. The method according to claim 7, further comprising:
allocating a virtual port that is not connected to an actual device, to the preview object unit.

11. The method according to claim 10, further comprising:
allocating a plurality of virtual ports that are not connected to an actual device, to the preview object unit.

12. A method in an information processing apparatus, the method comprising:
causing a preview object unit to generate a preview document based on document data stored in a preview print queue; and
causing a document transmission object unit to send the preview document to a server device registering a print command generation print queue.

13. A computer-readable storage medium storing a program for causing a computer to function as a preview object unit configured to generate a preview document based on document data stored in a preview print queue, display the preview document on a screen, and store the preview document in a print command generation print queue; and
a print command generation object unit configured to generate a print command based on the preview document stored in the print command generation print queue.

14. A computer-readable storage medium storing a program for causing a computer to function as a preview object unit configured to generate a preview document based on document data stored in a preview print queue and display the preview document on a screen; and
a document transmission object unit configured to send the preview document to a server device registering a print command generation print queue.

15. A printing system having a client device and a server device, the printing system comprising:
a unit configured to display a preview document based on document data stored in a print queue in the client device, and send the document data to a print queue in the server device; and
a unit configured to generate a print command based on the print queue in the server device, and send the generated print command to a printer.

16. An information processing apparatus comprising:
a first printer icon that is registered in a virtual port, and configured to display a preview document on a screen based on document data stored in a first queue and send the document data to a second queue; and
a second printer icon that is registered in a port connected to a printer, and configured to generate a print command based on the document data stored in the second queue.
